(19) United States
(12) Patent Application Publication
(10) Pub. No.: US 2026/0322492 A1
(43) Pub. Date: Oct. 15, 2026

(54) Active System and Method for Reliable Data Center Optical Links

(71) Applicant: KlatchWERX LLC, Dover, DE (US)

(72) Inventors: Alexander J. Hallock, Littleton, MA (US); Michael Vestel, San Francisco, CA (US)

(21) Appl. No.: 19/697,524

(22) Filed: Jun. 3, 2026

Related U.S. Application Data
(63) Continuation-in-part of application No. 19/550,233, filed on Feb. 25, 2026.
(60) Provisional application No. 63/787,112, filed on Apr. 11, 2025.
(60) Provisional application No. 63/916,055, filed on Nov. 12, 2025.

(51) Int. Cl. H04B 10/116; G02B 26/08; H04B 10/079; H04B 10/114; H04B 10/50

(52) U.S. Cl. CPC H04B 10/116; G02B 26/0816; H04B 10/0793; H04B 10/0795; H04B 10/1143; H04B 10/1149; H04B 10/505

(57) ABSTRACT

An active system and method for reliable data center optical links. The system encodes data onto modulated light, directs it through free space using beam steering elements, and converts it back into electrical signals at a receiver. Terminals autonomously locate partner terminals, establish precise alignment, and continuously correct for environmental disturbances including vibration, thermal drift, and airflow variation through closed-loop feedback. Beam steering elements may include optical phased arrays, liquid crystal spatial light modulators, MEMS mirrors, metasurfaces, or other solid-state or miniaturized steering mechanisms. Self-healing operation detects link disruptions and autonomously re-establishes connections through directed search and re-acquisition. A network-level orchestration method enables a centralized controller to manage link topologies across a plurality of terminals, supporting dynamic reconfiguration, redundancy, and scalability.

Priority is claimed in the application data sheet to the following patents or patent applications, each of which is expressly incorporated herein by reference in its entirety:

19/550,233

63/787,112

63/916,055

### BACKGROUND OF THE INVENTION

### Field of the Invention

The present invention relates to free space optical communications within data center environments, and more particularly to systems and methods for active pointing, acquisition, and tracking between optical terminals to establish and maintain reliable wireless optical data links between computing equipment in indoor facilities.

### Discussion of the State of the Art

Modern data centers rely on physical cabling to interconnect computing, storage, and networking equipment. As facilities scale and network topologies evolve, this cabling infrastructure presents increasing challenges. Installing, rerouting, or removing cables is labor intensive, cable density obstructs airflow and complicates thermal management, and each physical connection imposes a fixed topology that cannot be changed without manual intervention.

Free Space Optical (FSO) communication offers an alternative by transmitting data encoded in modulated light through air rather than through a physical medium. Light travels faster through air than through glass fiber, providing a latency advantage on every link. The optical carrier is immune to electromagnetic interference, is not subject to spectrum allocation constraints, and requires no physical medium between endpoints, eliminating cables as sources of airflow obstruction and enabling reconfigurable data paths through beam steering alone.

A variety of FSO systems have been built for outdoor and long-range applications, but these systems are designed around constraints that differ substantially from those encountered inside a data center. Outdoor systems must contend with weather, atmospheric turbulence, and long propagation distances, driving them toward large apertures, high-power lasers, and heavy mechanical gimbal assemblies. The indoor data center environment replaces those challenges with its own: short propagation distances of meters to tens of meters, eye safety requirements that constrain wavelength and power level selection, vibration from cooling fans and foot traffic, thermal gradients from computing equipment and directed airflow, and the need for five-nines (99.999%) availability demanding that alignment be actively monitored and corrected multiple times per second without human intervention.

What is needed is a free space optical communication system engineered specifically for the data center environment, combining active pointing, acquisition, and tracking with eye-safe operation, compact and scalable terminal design, dynamic link reconfigurability through software control, self-healing recovery from disruptions, and network-level orchestration across a plurality of terminals to meet the uptime, bandwidth, and operational requirements of modern high-performance computing infrastructure.

### SUMMARY OF THE INVENTION

The inventor has developed an active system and method for reliable data center optical links. The disclosed systems encode data onto modulated light, direct it through free space using beam steering elements, and convert it back into electrical signals at a receiver. Active beam steering enables the terminals to autonomously locate one another, establish alignment, and continuously compensate for environmental disturbances such as vibration, thermal drift, and airflow variation without manual intervention.

The invention includes multiple system architectures employing different beam steering technologies including optical phased arrays, liquid crystal spatial light modulators, MEMS mirrors, metasurfaces, and other solid-state or miniaturized steering mechanisms. Certain embodiments separate the alignment and data transmission functions onto independent beacon and signal channels, while others leverage commercially available transceivers to simplify integration with existing network infrastructure. The methods cover the full operational lifecycle of an optical link, from initial autonomous acquisition through active tracking and maintenance to self-healing recovery following disruptions. A network-level orchestration method enables a centralized controller to manage link topologies across a plurality of terminals, supporting dynamic reconfiguration, redundancy, and scalability.

The invention offers performance advantages over conventional wired and radio frequency alternatives. The optical signal propagates along a direct line-of-sight path through air, which provides lower latency than glass fiber and eliminates the routing constraints and excess cable length inherent in wired installations. The bandwidth of a free space optical link is not subject to the spectral allocation constraints that limit radio frequency systems, and the optical carrier is inherently immune to electromagnetic interference. The system is protocol agnostic and, in an exemplary embodiment, operates at infrared wavelengths selected to comply with applicable eye safety standards, enabling deployment in occupied facilities. The active pointing, acquisition, and tracking capability ensures high uptime by continuously maintaining optimal alignment and autonomously recovering from disruptions.

According to a preferred embodiment, an optical communication system for a data center environment comprising: a first terminal comprising a light source configured to generate a modulated optical signal encoding a data stream, a beam steering element configured to direct the modulated optical signal through free space toward a second terminal, and a controller configured to command the beam steering element; a second terminal comprising collection optics configured to receive the modulated optical signal from the first terminal, a detector configured to convert the received modulated optical signal into an electrical data stream, and a spatially sensitive detector configured to generate alignment information indicative of an angular offset between the modulated optical signal and the second terminal; a pointing, acquisition, and tracking system configured to perform an acquisition sequence in which the beam steering element scans an angular search region to locate the second terminal and iteratively refines alignment based on the alignment information until a signal quality metric exceeds a predetermined acquisition threshold; and a feedback system configured to continuously monitor the signal quality metric during an established communication link and to compute and apply steering corrections to the beam steering element to maintain alignment between the first terminal and the second terminal in the presence of environmental disturbances, is disclosed.

According to another preferred embodiment, a method for establishing and maintaining a free space optical communication link between a first terminal and a second terminal, the method comprising the steps of: activating a beacon signal on a first terminal, wherein the beacon signal emits light across an angular search region; scanning the angular search region using a beam steering element on the first terminal to sweep the beacon signal across candidate locations of a second terminal; detecting a return signal at the first terminal indicating an angular direction of the second terminal; computing a coarse alignment vector based on the detected return signal and direct the beam steering element toward an estimated location of the second terminal; refining alignment by iteratively adjusting the beam steering element based on feedback from a spatially sensitive detector until a signal quality metric exceeds a predetermined acquisition threshold; establishing a modulated data link between the first terminal and the second terminal by transmitting encoded optical data along a refined alignment vector; monitoring the signal quality metric during the established modulated data link and computing a steering correction vector when the signal quality metric falls below a predetermined maintenance threshold; and applying the steering correction vector to the beam steering element to maintain alignment in the presence of environmental disturbances, is disclosed.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture for a free space optical communication link between two computing equipment racks in a data center environment.

FIG. 2 is a block diagram illustrating an exemplary beam steering assembly employing galvanometer-driven mirrors for directing a laser beam to an arbitrary angular position in two axes.

FIG. 3 is a block diagram illustrating an exemplary acquisition method employing a retroreflector to enable a transmitting terminal to detect alignment with a partner terminal without requiring an active response or side-channel communication from the partner.

FIG. 4 is a block diagram illustrating an exemplary position-sensitive detection arrangement for measuring the angular alignment of an incoming optical beam relative to a receiving terminal.

FIG. 5 is a block diagram illustrating an exemplary dual-beam optical architecture that separates the data transmission function and the alignment tracking function onto independent signal and beacon channels.

FIG. 6 is a block diagram illustrating an exemplary complete terminal architecture for a single optical terminal in a data center free space optical communication system, showing the integration of the transmit, receive, alignment, and control subsystems into a unified system under the coordination of a central processor.

FIG. 7 is a block diagram illustrating an exemplary relay-assisted system architecture for a free space optical communication link between two computing equipment racks in a data center environment where a direct line-of-sight path between the two rack-mounted optical terminals is unavailable or impractical.

FIG. 8 is a flow diagram illustrating an exemplary method for establishing and maintaining a free space optical communication link between a first terminal and a second terminal within a data center environment.

FIG. 9 is a flow diagram illustrating an exemplary method for self-healing recovery and relay-assisted reconfiguration of a free space optical communication link within a data center environment.

FIG. 10 illustrates an exemplary computing environment on which an embodiment described herein may be implemented.

### DETAILED DESCRIPTION OF THE INVENTION

The inventor has conceived, and reduced to practice, an active system and method for reliable data center optical links. The present invention pertains to systems and methods for establishing, maintaining, and recovering free space optical communication links between terminals using active pointing, acquisition, and tracking. The systems transmit data by encoding it onto modulated light and directing it through free space to a receiver, where the light is converted back into an electrical data signal. Unlike conventional static optical links that rely on fixed alignment, the disclosed systems employ active beam steering elements to autonomously locate partner terminals, establish precise alignment, and continuously correct for environmental disturbances including thermal drift, vibration, airflow variation, and physical obstructions. The active tracking capability enables self-healing operation in which a disrupted link is automatically detected, classified, and re-established without manual intervention, as well as dynamic reconfiguration in which communication paths can be redirected between different terminal pairs in response to changing network requirements.

Several embodiments of the beam steering and link architecture are disclosed. In one embodiment, an optical phased array electronically steers a shaped beam by controlling the relative phase across a plurality of emitting elements to create a programmable interference pattern, enabling fully solid-state operation with no mechanical movement. In another embodiment, a beacon-based acquisition system operates alongside a liquid crystal spatial light modulator that steers the communication signal, separating the alignment and data transmission functions onto independent optical channels for optimized performance of each. In a further embodiment, commercially available Small Form-factor Pluggable transceiver devices are paired with reflective liquid crystal spatial light modulators and collimating optics to leverage existing networking components and standard data processing protocols. The beam steering element in any of these embodiments may alternatively comprise a MEMS mirror, a metasurface, a digital micromirror device, Risley prisms, liquid lenses, or any other suitable steering technology, as the disclosed system architectures are agnostic to the specific steering mechanism employed.

The disclosed methods address the full operational lifecycle of a free space optical link, including autonomous acquisition in which terminals locate and connect to one another without manual intervention, active tracking in which a closed-loop feedback system continuously monitors signal quality and applies corrective steering adjustments, and self-healing in which link disruptions are detected and autonomously recovered through directed search and re-acquisition. A network-level orchestration method is further disclosed in which a centralized controller manages a plurality of terminals within a deployment environment, computing link topologies, issuing assignment and reconfiguration instructions, and monitoring aggregate network health. The disclosed systems and methods are particularly suited to data center environments where stability, turnkey installation, scalability, reconfigurability, and high uptime are critical operational requirements, and where the line-of-sight propagation path, protocol agnosticism, electromagnetic interference immunity, and latency advantages of free space optical communication offer performance benefits over conventional wired or radio frequency alternatives.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the description. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present invention, and in which are shown, by way of illustration, specific arrangements of one or more of the aspects. It should be appreciated, however, that such features are not limited to usage in the one or more particular aspects or figures with reference to which they are described. The present application is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

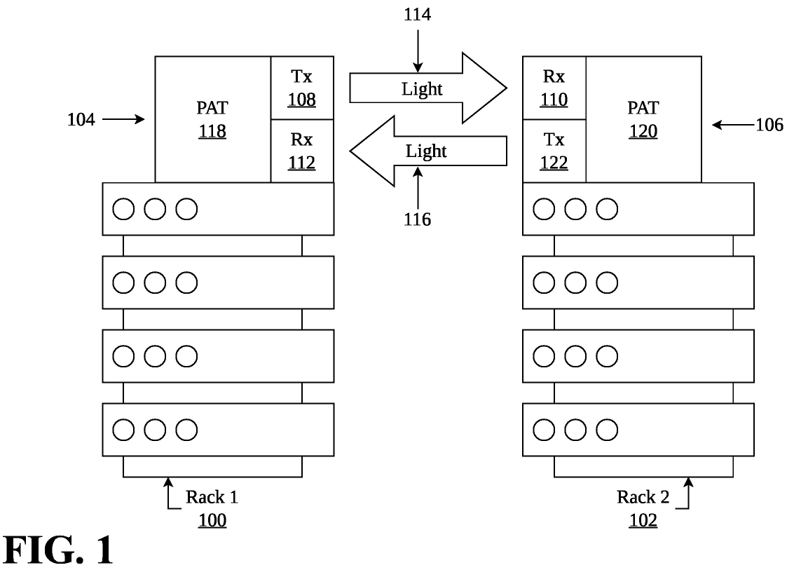

FIG. 1 is a block diagram illustrating an exemplary system architecture for a free space optical communication link between two computing equipment racks in a data center environment. A first rack 100 is situated across from a second rack 102 within a data center facility, with data exchanged between them over a free space optical link that traverses the air gap separating the two racks. In a typical data center deployment, first rack 100 and second rack 102 may be server racks, storage racks, or networking racks arranged in rows within a data hall, separated by distances ranging from a few meters between adjacent racks in the same row to tens of meters across aisles or between opposing rows. A first optical terminal 104 is mounted on or adjacent to first rack 100 and a second optical terminal 106 is mounted on or adjacent to second rack 102. In an exemplary embodiment, optical terminal 104 and optical terminal 106 may be mounted on top of their respective racks in a top-of-rack configuration, taking advantage of the unobstructed line of sight available above the equipment to avoid interference from cables, cable trays, and other infrastructure occupying the lower portions of the rack environment. In another exemplary embodiment, optical terminal 104 and optical terminal 106 may be mounted at the end of a rack row, on a ceiling-mounted bracket, or at any other location that provides a clear optical path between the two terminals.

Optical terminal 104 includes a transmitter 108 that generates a modulated optical signal encoding a data stream received from the computing equipment in rack 100. Transmitter 108 receives input data from a host network device through any standard network interface including, by way of example, an Ethernet connection, a fiber channel interface, or any protocol-agnostic data source. In an exemplary embodiment, transmitter 108 may incorporate a Small Form-factor Pluggable (SFP) transceiver device that accepts input data from a host network switch, encodes it onto a modulated optical signal, and outputs that signal through a fiber optic port, enabling the free space optical link to appear to the host network as a conventional fiber connection. Transmitter 108 includes a laser source that generates a coherent optical carrier onto which data is encoded by varying one or more properties of the light, such as intensity, phase, or polarization, in accordance with the data stream. The laser source may operate at any suitable wavelength, and in an exemplary embodiment operates in the infrared spectrum at a wavelength and power level selected to comply with eye safety limits such as IEC 60825-1 Class 1 limits, ensuring that no accessible emission exceeds the maximum permissible exposure for the eye under any operational condition and enabling deployment in occupied data center facilities without requiring restricted access zones or additional safety enclosures. Where additional optical power is required, an amplifier may be incorporated at or after the laser source to increase the output power of the optical signal while remaining within applicable eye safety limits. On-off keying is one exemplary modulation scheme in which binary data is represented by the presence or absence of optical power, though other encoding standards may be employed depending on the data rate and link budget requirements.

Optical terminal 106 includes a receiver 110 that collects incoming light 114 from transmitter 108 and converts it back into an electrical data signal for delivery to the computing equipment in rack 102. Receiver 110 includes collection optics that gather incoming light 114 and focus it onto a detector. The collection optics may be a lens, a telescope, or any suitable optical assembly dimensioned to provide an effective receive aperture for the expected range and beam divergence of the indoor link. The detector converts the received optical signal back into an electrical signal representing the originally transmitted data. The detector may be, by way of example, a photodiode, an avalanche photodiode, an InGaAs photodiode, or a quantum well infrared photodetector, selected based on the operating wavelength and sensitivity requirements of the link. Where the received signal strength is insufficient for reliable detection, an optical amplifier may be incorporated upstream of the detector to increase the power of the collected signal. Receiver control electronics interpret the electrical signal produced by the detector, decode the transmitted data, and provide output data in a format compatible with the receiving network infrastructure. In an exemplary embodiment, receiver 110 may incorporate an SFP transceiver device that receives the optical signal through a fiber port, detects and demodulates the light, and outputs the recovered data to a host network switch, allowing the free space optical link to integrate transparently with the existing data center network.

For data to flow in both directions, optical terminal 106 includes a transmitter 122 that generates a modulated optical signal directed back toward optical terminal 104, and optical terminal 104 includes a receiver 112 that collects incoming light 116 from transmitter 122 and converts it into an electrical data signal. This arrangement enables full-duplex communication between rack 100 and rack 102 over the free space optical link. In an exemplary embodiment, optical terminal 104 and optical terminal 106 may each be implemented as a unified transceiver that combines transmitter and receiver functionality into a single device sharing common optics, wherein a single output lens or aperture assembly serves both the transmit and receive functions simultaneously. Beam splitters, circulators, or wavelength-division elements within the transceiver separate the outgoing and incoming signals so that transmitted light does not interfere with received light despite sharing the same optical path. In an exemplary embodiment, each transceiver may utilize slightly different wavelengths for the transmit and receive directions, allowing wavelength-selective filters to cleanly isolate the two signals while still sharing common optics, an approach well established in fiber optic networking and already implemented in commercially available bidirectional SFP transceiver devices. The shared optical path ensures that the transmit and receive directions are coaligned through the same beam steering element, reducing the number of independent alignment corrections required to maintain a stable bidirectional link and enabling a more compact terminal design suitable for dense data center deployments where a large number of terminals may need to be installed in a confined space.

Optical terminal 104 includes a PAT module 118 and optical terminal 106 includes a PAT module 120, each responsible for the pointing, acquisition, and tracking functions that establish and maintain alignment between the two terminals. PAT module 118 and PAT module 120 each include a beam steering element that directs the modulated optical beam toward the partner terminal and, in a transceiver configuration, simultaneously defines the effective receive field of view. The beam steering element may be any of a variety of technologies including, by way of example, a MEMS mirror, an optical phased array, a liquid crystal spatial light modulator, a metasurface, a digital micromirror device, Risley prisms, liquid lenses, galvanometer-driven mirrors, acousto-optic modulators, electro-optic modulators, or any other suitable steering mechanism. In an exemplary embodiment, a pair of galvanometer-driven mirrors mounted at right angles to one another may steer the beam to an arbitrary position in two axes, with each mirror connected to a galvanometer motor that provides precise angular control through piezoelectric or voice coil actuation. In an exemplary embodiment, an optical phased array may electronically steer the beam by controlling the relative phase across a plurality of emitting elements to create a programmable interference pattern, enabling fully solid-state operation with no mechanical movement and response times on the order of microseconds to nanoseconds. In an exemplary embodiment where both wide angular coverage for initial acquisition and fine angular precision for sustained tracking are required, a hybrid steering architecture may combine a coarse steering element that provides wide-angle coverage across a large field of regard with a fine steering element that provides high-precision angular control over a narrower range, with a controller managing the handoff between the two based on the residual angular offset reported by a spatially sensitive detector.

During initial deployment, each optical terminal may be installed on its respective rack and sighted approximately by an installer to provide a starting orientation. PAT module 118 and PAT module 120 then execute an autonomous acquisition sequence to locate one another and establish the optical link without further manual intervention. In the acquisition sequence, the beam steering element scans an angular search region to systematically sweep a beacon or the transmitted beam itself across candidate partner locations. The scan pattern may follow a raster, spiral, or other predetermined trajectory designed to ensure complete coverage of the search region within an acceptable time window. The partner terminal is detected using a spatially sensitive detector, such as a quad photodiode comprising four independent sensing quadrants, that determines the angular direction of the incoming light by comparing the relative power levels across the quadrants. Upon detection, a coarse alignment vector is computed and the beam steering element is directed toward the estimated location of the partner terminal. Alignment is then iteratively refined based on continuous feedback from the spatially sensitive detector until a signal quality metric, which may include received optical power, bit error rate, or spatial offset on the position-sensitive detector, exceeds a predetermined acquisition threshold. In an exemplary embodiment, the acquisition sequence may employ a dedicated beacon light source operating at a wavelength distinct from the communication signal, enabling the terminals to locate one another using the beacon channel while the communication signal channel remains available for data transmission as soon as alignment is achieved. In another exemplary embodiment, a retroreflector at the receiving terminal may return a portion of incident light back toward the transmitting terminal, enabling the transmitter to detect alignment without requiring an active response from the receiver and facilitating acquisition in configurations where a side-channel communication path has not yet been established. In an exemplary embodiment, additional location and pointing information may be provided by a camera that actively monitors the scene and provides image analysis data to the PAT module, particularly where the partner terminal carries an identifiable mark or beacon that can be located in a camera frame to compute the required pointing direction.

In an exemplary embodiment, initial location and orientation estimates may be provided by GPS coordinates, inertial measurement units (IMUs), or data exchanged between terminals over a WiFi connection or wired management interface, enabling the PAT module to narrow the angular search region prior to scanning and reduce the time required to complete the acquisition sequence. In an exemplary embodiment where both terminals are in communication over an auxiliary channel such as WiFi or a wired cable prior to optical acquisition, the receiver of one terminal may signal over the auxiliary channel when it detects light from the transmitter of the other terminal, providing a cooperative acquisition feedback path that confirms alignment without requiring a retroreflector or a beacon and enabling the two terminals to coordinate their scanning sequences for faster convergence.

Once the link is established, PAT module 118 and PAT module 120 transition to active tracking mode in which the signal quality of the established link is continuously monitored and steering corrections are computed and applied to maintain alignment. The data center environment introduces a characteristic set of disturbances that the tracking system must reject, including vibration from cooling fans, compressors, hard disk drives, and foot traffic; thermal drift caused by localized heat generation from computing equipment and directed airflow from cooling systems that create persistent temperature gradients along the optical path; and transient obstructions caused by personnel or equipment moving through the beam path during maintenance or installation activities. PAT module 118 and PAT module 120 compare the signal quality metric against a predetermined maintenance threshold and, when the metric falls below the threshold, compute a steering correction vector based on the deviation of the received signal from an optimal alignment reference, accounting for angular offset in at least two axes. The correction vector is translated into the appropriate control signals for the beam steering element, and the resulting angular adjustment redirects the beam to compensate for the detected misalignment. In an exemplary embodiment, the correction vector may be computed using a proportional-integral-derivative control algorithm that accounts for the current offset, accumulated drift over time, and the rate of change of the misalignment. In an exemplary embodiment, the tracking system may employ a power optimization technique in which the beam steering element applies small deliberate perturbations, or dithers, to the beam direction while monitoring the received optical power, and adjusts the nominal beam pointing to maintain the direction that maximizes the received power. This dithering approach provides a gradient-based alignment signal that does not require a spatially sensitive detector and can serve as a standalone tracking method or as a supplementary measurement fused with the spatial offset data from a position-sensitive detector. In an exemplary embodiment, a Kalman filter or similar state estimation technique may be employed to separate true alignment drift from measurement noise. The monitoring and correction cycle repeats at a predetermined update rate, which may range from a few iterations per second for relatively stable deployments to hundreds or thousands of iterations per second for environments subject to rapid vibration. In an exemplary embodiment, the update rate may be adaptively adjusted based on observed link stability, increasing during periods of high disturbance and decreasing during stable conditions.

In an exemplary embodiment, the signal quality metric may include data throughput or data rate measurements, enabling the tracking system to detect not only complete signal loss but also partial degradation such as a reduction in effective throughput that may indicate a slight misalignment developing before the link is fully disrupted, allowing corrective action to be taken while the communication link remains operational.

PAT module 118 and PAT module 120 may further store tracking history data comprising recent steering corrections and signal quality trends, enabling predictive adjustment of the beam steering element to compensate for periodic or anticipated disturbances. The accumulated history captures the temporal pattern of alignment corrections over time, revealing periodic disturbances such as thermal expansion cycles, mechanical vibrations from nearby equipment, or diurnal cooling system variations. In an exemplary embodiment, machine learning or artificial intelligence routines may analyze the stored tracking history to build predictive models that anticipate future alignment drift and apply preemptive corrections before the signal quality degrades, reducing effective tracking latency and improving link stability beyond what purely reactive correction can achieve. In an exemplary embodiment, reinforcement learning techniques may be employed to continuously optimize the correction strategy based on observed outcomes, adapting to changes in the disturbance environment over time without requiring manual recalibration. In an exemplary embodiment, sensor fusion techniques combining data from the spatially sensitive detector, a camera, power monitoring, and any available side-channel information from the partner terminal may be used to provide a more robust assessment of alignment state than any single measurement source alone.

PAT module 118 and PAT module 120 further support self-healing operation in which link disruptions are detected, classified, and autonomously recovered. A link disruption event is detected when the signal quality metric falls below a predetermined disruption threshold, set below the maintenance threshold, for a duration exceeding a timeout period. The timeout period prevents momentary signal fluctuations caused by transient events from being mischaracterized as true disruptions. Upon detection, the disruption is classified as either a temporary obstruction or a persistent failure based on the duration and characteristics of the signal loss. A temporary obstruction, such as a person walking through the beam path, triggers a hold state in which the beam steering element maintains its current alignment and monitors for signal return within a predefined hold window, preserving the last known good alignment so that the link can resume immediately when the obstruction clears. A persistent failure, or expiration of the hold window without signal return, triggers a recovery sequence in which a directed search is executed by scanning the beam steering element across a narrowed angular region centered on the last known position of the partner terminal. The directed search covers a reduced angular region compared to the full acquisition search, exploiting prior knowledge of where the partner terminal was last successfully tracked to accelerate recovery. Upon successful re-acquisition, fine alignment and link confirmation are performed to re-establish the data link to the same quality standards as the initial acquisition.

In an exemplary embodiment, PAT module 118 and PAT module 120 may exchange alignment status information over an auxiliary channel to enable coordinated tracking in which both terminals contribute to maintaining optimal alignment rather than relying on a single terminal to bear the full correction burden. The auxiliary channel may be, by way of example, a low-bandwidth radio frequency link, an in-band optical sideband, or control data encoded onto the beacon signal at a modulation rate orders of magnitude lower than the data rate of the communication channel. In an exemplary embodiment, the beacon light source may serve a dual function as both a spatial reference for alignment and a low-bandwidth control communication channel between the terminals, with transmitter control electronics modulating the beacon emission to encode operational status, coordination commands, and alignment data. This dual-function beacon approach enables fully autonomous inter-terminal coordination without requiring any external communication path, including radio frequency links or wired cables, which may be unavailable, impractical, or prohibited in the data center environment.

The architecture illustrated in FIG. 1 replaces the conventional physical cable connection between rack 100 and rack 102 with a free space optical link that provides several operational advantages in the data center environment. Because light 114 and light 116 propagate through air along a direct line-of-sight path, the communication link follows the shortest geometric distance between the two terminals, and light travels faster through air than through glass fiber, providing a measurable latency reduction on every link. Eliminating the physical cable between the racks removes a source of airflow obstruction in environments where cooling efficiency is a primary operational concern, and eliminates the labor and time associated with installing, rerouting, and managing cable infrastructure. Because the optical links carry no electrical current between terminals, they introduce no galvanic coupling or ground loop paths between connected equipment. The beam steering capability of PAT module 118 and PAT module 120 enables the communication path to be dynamically reconfigured through software control, so that optical terminal 104 may be redirected to communicate with a different partner terminal on a different rack without physical intervention, creating a programmable optical interconnect fabric that can adapt to changing workloads, equipment additions, and failure conditions. The system is protocol agnostic, capable of transmitting any standard data format without requiring protocol-specific hardware or conversion at the optical layer, and in an exemplary embodiment may support data rates compatible with standard Ethernet speeds including 1 Gbps, 10 Gbps, 25 Gbps, 40 Gbps, and 100 Gbps by selecting appropriate SFP transceiver devices.

In an exemplary embodiment, the free space optical link may replace one or more intermediate network switches, media converters, or patch panels that would otherwise be required to route data between rack 100 and rack 102 through a wired infrastructure, eliminating the electrical power consumption and heat generation associated with those intermediate devices and reducing the aggregate cooling load on the data center facility.

In an exemplary embodiment, the aggregate bandwidth of the free space optical link may be increased beyond the capacity of a single transceiver channel by multiplexing multiple data streams onto a single optical beam prior to free space transmission. Wavelength Division Multiplexing (WDM) is a particularly suitable approach because it allows multiple independent data streams, each carried on a distinct optical wavelength, to be combined into a single co-propagating beam for transmission and separated again at the receiver, without requiring the PAT system to manage more than one physical beam path. Reducing all multiplexed channels to a single free space beam is advantageous because it keeps the pointing, acquisition, and tracking system as simple and robust as possible — a single beam requires only one set of steering optics, one acquisition sequence, and one closed-loop tracking process regardless of how many data channels are multiplexed onto it. Commercial WDM components supporting aggregate capacities well in excess of one terabit per second are available using standard off-the-shelf multiplexer and demultiplexer modules, enabling scalable bandwidth expansion without modification to the free space optical path or the PAT system.

In an exemplary embodiment, an optical circulator may be combined with a wavelength-division multiplexer to reduce a full-duplex bidirectional link to a single physical free space beam. The multiplexer combines multiple transmit channels of distinct wavelengths into a single composite transmit path, and a corresponding multiplexer aggregates the receive channels similarly. An optical circulator, a passive device that routes light from one port to another in one direction only, then combines the composite transmit and receive paths onto one shared lane for transmission through the free space link. By way of example, four duplex transceiver pairs each operating at 10 Gbps on distinct wavelengths may be multiplexed and combined through a circulator to produce a single 40 Gbps bidirectional free space beam, with the process reversed at the receiving terminal to recover the individual channels. This approach is particularly advantageous for free space optical systems because, unlike fiber installations where running a small number of parallel fibers adds little complexity, the free space case strongly favors minimizing the number of independently steered beams; a single beam managed by one PAT system is substantially simpler and more reliable than an array of parallel beams each requiring independent acquisition and tracking. In an alternative exemplary embodiment, bidirectional Small Form-factor Pluggable transceiver devices, which transmit and receive on different wavelengths over a single optical lane, may be multiplexed together to achieve a single-beam bidirectional free space link without requiring an optical circulator, as the wavelength separation between the transmit and receive directions inherent in each bidirectional transceiver eliminates the need for a circulator to combine them. The selection between these approaches may be made based on available wavelength channels, target aggregate bandwidth, and cost and availability of suitable transceiver components.

In an exemplary embodiment, spatial multiplexing may be employed as an alternative or supplementary bandwidth expansion technique in which multiple independent free space beams, each carrying a separate data stream, are transmitted in parallel between two terminals. Each beam may operate at the same or different wavelengths, provided the beams remain sufficiently separated at the receiver that each illuminates only its designated detector without crosstalk onto adjacent detector elements. In contrast to wavelength-division multiplexing, spatial multiplexing requires each beam to be independently acquired, tracked, and steered, increasing the complexity of the PAT architecture relative to the single-beam case. Spatial multiplexing may be advantageous where WDM component availability or cost constrains the number of achievable wavelength channels, but the additional tracking complexity represents a significant tradeoff relative to the single-beam WDM approach.

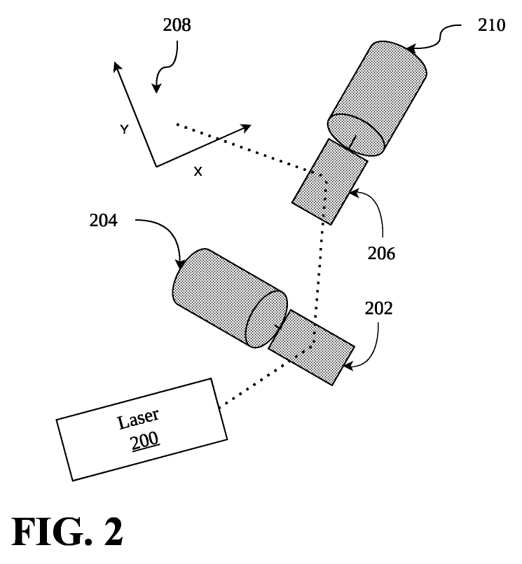

FIG. 2 is a block diagram illustrating an exemplary beam steering assembly employing galvanometer-driven mirrors for directing a laser beam to an arbitrary angular position in two axes. This embodiment represents one exemplary implementation of the beam steering element within the PAT modules described with respect to FIG. 1, and is particularly suited to data center deployments where the beam steering element must be capable of rapidly and precisely redirecting the optical beam across a bounded angular range to locate, acquire, and continuously track a partner terminal.

A laser 200 generates a coherent beam of light that serves as either the modulated communication signal, a beacon signal for acquisition, or both, depending on the system configuration. Laser 200 may operate at any suitable wavelength, and in an exemplary embodiment operates in the infrared spectrum at a wavelength and power level selected to comply with applicable eye safety standards for deployment in occupied data center facilities. The beam emitted by laser 200 is directed onto a first mirror 202 that is mechanically coupled to a first galvanometer 204. First galvanometer 204 is a limited-rotation motor that converts an electrical control signal into a precise angular displacement of first mirror 202 about a single rotational axis. As first galvanometer 204 rotates, first mirror 202 deflects the incoming beam at a corresponding angle, sweeping the reflected beam across one axis of the output field. The angular position of first mirror 202 is directly and repeatably determined by the magnitude of the electrical control signal applied to first galvanometer 204, enabling the beam to be directed to a specific angular position along this axis with known precision and response time.

The beam reflected from first mirror 202 is directed onto a second mirror 206 that is mechanically coupled to a second galvanometer 210. Second mirror 206 and second galvanometer 210 are mounted at an angle to first mirror 202 and first galvanometer 204, providing angular control in an orthogonal axis. The combined action of the two mirror-galvanometer pairs enables the beam to be steered to an arbitrary (X, Y) position 208 within the accessible angular field of the assembly. By independently commanding the two galvanometers, the PAT module can direct the beam to any point within a two-dimensional angular region, enabling the full range of pointing, acquisition, and tracking operations required to establish and maintain an optical link.

During the acquisition phase, the PAT module commands first galvanometer 204 and second galvanometer 204 to execute a coordinated scan pattern that systematically sweeps position 208 across the angular search region in which a partner terminal is expected to be located. The scan pattern may follow a raster, spiral, or other predetermined trajectory designed to ensure complete coverage of the search region. As the beam sweeps across candidate locations, a spatially sensitive detector on the partner terminal, or a retroreflector returning light back to the transmitting terminal, provides the feedback signal that indicates when the beam has found the partner. Upon detection, the galvanometers are commanded to hold the beam in the approximate direction of the partner while alignment is iteratively refined based on feedback from a position-sensitive detector until the signal quality metric exceeds the acquisition threshold.

During steady-state tracking, the PAT module continuously adjusts the control signals applied to first galvanometer 204 and second galvanometer 210 to maintain precise alignment as environmental conditions change. The steering corrections computed by the tracking feedback loop are translated into incremental angular adjustments of the two galvanometers, with each correction redirecting position 208 by the amount and in the direction necessary to compensate for detected misalignment. Because galvanometer-driven mirrors provide continuous analog angular control with response times on the order of, for example, hundreds of microseconds to low milliseconds, the assembly can reject vibration, thermal drift, and airflow-induced beam deflection at update rates of hundreds to thousands of corrections per second, sufficient to maintain the alignment precision required for reliable data transmission in a data center environment.

The galvanometers may be actuated by any of several drive mechanisms depending on the response speed, angular range, and precision required for a given deployment. In an exemplary embodiment, the galvanometers may employ voice coil actuators that provide rapid, low-inertia angular displacement well suited to the high-frequency correction bandwidths required for vibration rejection. In an exemplary embodiment, piezoelectric actuators may be used where extremely fine angular resolution is required over a narrower range of motion. The mirrors themselves may be flat or curved depending on the optical design of the terminal, and additional mirrors may be incorporated into the beam path where the optical layout requires folding or redirecting the beam within a compact terminal enclosure. The galvanometer-mirror assembly may be implemented using commercially available galvanometer scanner modules, which are manufactured in volume for applications including laser marking, scanning microscopy, and additive manufacturing, providing a mature and cost-effective component base for scalable data center deployment. In an exemplary embodiment, the mirrors and galvanometers may be miniaturized using MEMS fabrication techniques, producing a functionally equivalent steering assembly at a reduced size suitable for integration into high-density terminal arrays. In an exemplary embodiment where both wide angular coverage and fine angular precision are required, the galvanometer-mirror assembly may serve as the coarse steering element in a hybrid steering architecture, providing rapid wide-angle coverage during acquisition while a fine steering element such as an optical phased array, a liquid crystal spatial light modulator, or a metasurface provides high-precision corrections during steady-state tracking.

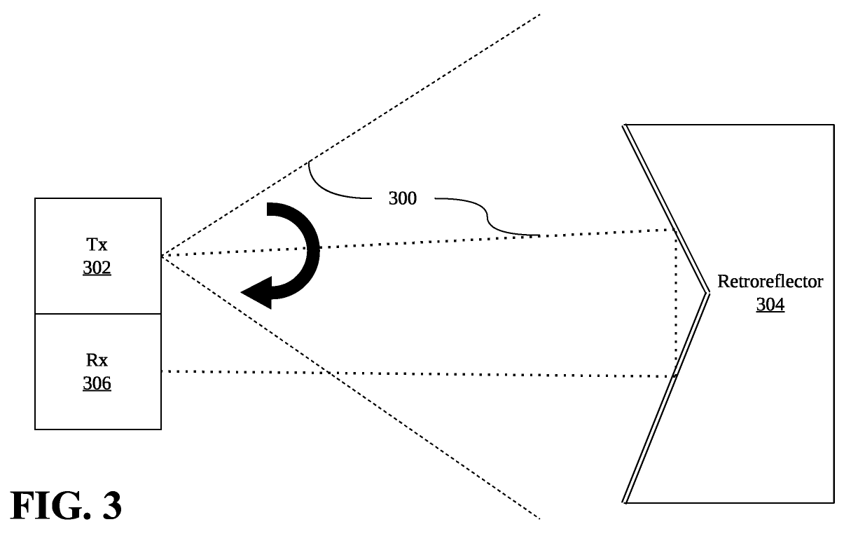

FIG. 3 is a block diagram illustrating an exemplary acquisition method employing a retroreflector to enable a transmitting terminal to detect alignment with a partner terminal without requiring an active response or side-channel communication from the partner. This acquisition approach is particularly advantageous in data center deployments during initial installation or following a system reset, where a communication link between the two terminals has not yet been established and no auxiliary channel such as a WiFi connection, wired cable, or radio frequency link is available to coordinate the acquisition process.

A transmitter 302 emits a laser beam 300 that is swept across the scene by a beam steering element under the control of the PAT module. The beam steering element, which may be implemented using galvanometer-driven mirrors as described with respect to FIG. 2 or any other suitable steering technology, systematically scans laser beam 300 across an angular search region encompassing the candidate locations where a partner terminal may be situated. The scan pattern is illustrated as a fan-shaped sweep, though in practice the scan may follow a raster, spiral, or other trajectory selected to provide complete coverage of the search region within an acceptable acquisition time. Laser beam 300 may be the same laser source used for data transmission, a dedicated beacon laser, or a separate acquisition laser, depending on the system configuration. In an exemplary embodiment, laser beam 300 may operate at a wavelength and power level selected to comply with applicable eye safety standards while providing sufficient optical intensity to produce a detectable retroreflected return across the expected range within the data center facility.

A retroreflector 304 is mounted on or adjacent to the partner terminal at the opposite end of the intended link. Retroreflector 304 is a passive optical element that returns incoming light back toward its source along a path parallel to the incident direction, regardless of the angle at which the light arrives, within the acceptance angle of the retroreflector. This property means that when laser beam 300 strikes retroreflector 304 during the scanning sweep, a portion of the incident light is reflected directly back toward transmitter 302 without requiring the partner terminal to actively detect, process, or respond to the incoming beam. Retroreflector 304 may be, by way of example, a corner cube retroreflector that uses three mutually perpendicular reflective surfaces to reverse the direction of incoming light, a cat’s eye retroreflector using a lens and mirror combination, or a retroreflective tape or film applied to the partner terminal housing. The retroreflector requires no electrical power, no control electronics, and no communication interface, making it a simple and reliable acquisition aid that adds minimal cost, complexity, and size to the partner terminal.

A receiver 306 is co-located with transmitter 302 on the transmitting terminal. Receiver 306 monitors for the return of reflected light from retroreflector 304 as the beam steering element scans laser beam 300 across the search region. When laser beam 300 is aimed at an angular position that does not correspond to retroreflector 304, no significant reflected signal is returned and receiver 306 detects only background light and noise. When laser beam 300 sweeps onto retroreflector 304, the retroreflected return produces a detectable signal at receiver 306, indicating that the beam is aimed in the direction of the partner terminal. The PAT module records the angular position of the beam steering element at the instant receiver 306 detects the retroreflected return, establishing a coarse alignment vector toward the partner terminal. Receiver 306 may be, by way of example, a photodiode, an avalanche photodiode, or a position-sensitive detector capable of measuring both the presence and the spatial offset of the incoming retroreflected light, providing not only detection of alignment but also directional information for refining the alignment estimate.

Once the coarse alignment vector is established through detection of the retroreflected return, the PAT module transitions from the scanning sweep to an iterative refinement phase in which the beam steering element makes progressively smaller angular adjustments around the detected direction while receiver 306 monitors the strength and spatial characteristics of the retroreflected signal. With each iteration, the beam direction is adjusted to maximize the retroreflected return until the alignment is sufficiently precise to establish the communication data link. At this point the system may transition from retroreflector-based acquisition to active tracking using the communication signal itself, a dedicated beacon channel, or a spatially sensitive detector as described with respect to FIG. 1, and the retroreflector continues to serve as a passive alignment aid that is available for re-acquisition should the link be disrupted and need to be re-established through the self-healing recovery sequence.

In an exemplary embodiment, both terminals may each incorporate a transmitter, a receiver, and a retroreflector, enabling both sides to independently discover and acquire the partner terminal through simultaneous retroreflector-based scanning, reducing the total acquisition time by allowing both terminals to contribute to the search process in parallel. In an exemplary embodiment, the retroreflector-based acquisition described herein may operate in combination with other acquisition methods, such as beacon-based tracking, camera-assisted image analysis, or side-channel coordination over WiFi or a wired management interface, providing redundancy in the acquisition process and enabling the system to establish alignment through whichever method succeeds first. In an exemplary embodiment, transmitter 302 and receiver 306 may share common optical elements and accomplish more than one task, for example detecting retroreflected light during acquisition and receiving modulated data once the link is established, thereby reducing the component count and terminal size. The alignment and data systems may share optical elements or may be implemented as entirely independent subsystems with no elements in common, depending on the design requirements of the deployment.

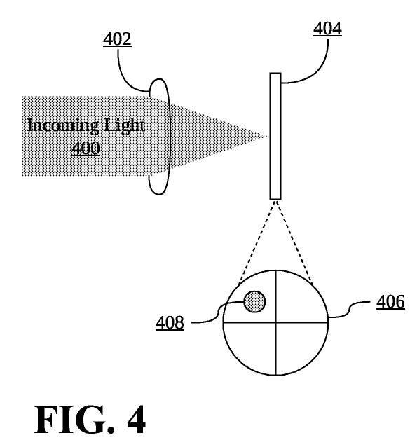

FIG. 4 is a block diagram illustrating an exemplary position-sensitive detection arrangement for measuring the angular alignment of an incoming optical beam relative to a receiving terminal. This detection arrangement provides the real-time spatial feedback used by the PAT modules described with respect to FIG. 1 to compute steering corrections during both the acquisition refinement phase and steady-state active tracking, and represents the spatially sensitive detector referenced in the system architectures disclosed herein.

Incoming light 400 arrives at the receiving terminal from the partner terminal across the free space optical path separating the two terminals within the data center. Incoming light 400 may be the modulated communication signal, a dedicated beacon signal operating at a wavelength distinct from the communication channel, a retroreflected return, or a combination thereof, depending on the operational mode of the system at the time of measurement. A lens 402 collects incoming light 400 and focuses it to a concentrated spot on a position-sensitive detector 404. Lens 402 may be a single aspheric element, a multi-element lens assembly, or any suitable focusing optic dimensioned to produce a spot size appropriate for the active area of position-sensitive detector 404 and the angular resolution required by the tracking system. The focal length of lens 402 determines the mapping between the angular offset of incoming light 400 and the physical displacement of the focused spot on the detector surface: a given angular misalignment between the two terminals translates into a proportional lateral shift of the spot, with the conversion factor set by the focal length. A longer focal length provides greater spot displacement per unit angle, increasing angular measurement sensitivity at the cost of a narrower field of view, while a shorter focal length provides a wider field of view at the cost of reduced per-angle sensitivity. In a data center deployment where the range of expected angular drift is bounded by the mechanical stability of the rack-mounted terminals and the environmental disturbance profile of the facility, the focal length may be selected to balance sensitivity against the angular range that must be accommodated without the spot falling off the detector.

Position-sensitive detector 404 is shown in the exemplary embodiment of FIG. 4 as a quad photodiode, which is a detector comprising four independent photosensitive quadrants arranged in a two-by-two grid separated by narrow gaps along two orthogonal axes. A face-on view 406 illustrates the four quadrants of the quad photodiode with a focused spot 408 falling within one of the four sectors. Each quadrant is a separate photodetector that produces an electrical output proportional to the optical power incident upon it. When the incoming beam is perfectly aligned with the receiving terminal, lens 402 focuses the spot precisely at the center of the quad photodiode where the four quadrants meet, and each quadrant receives an equal share of the optical power, producing four balanced electrical outputs. When the alignment between the two terminals drifts, the focused spot shifts away from the center and falls preferentially onto one or two quadrants, producing an imbalance in the electrical outputs that encodes both the magnitude and the direction of the misalignment in two axes.

The PAT module computes the angular offset of the incoming beam from the electrical outputs of the four quadrants by calculating a normalized difference signal for each axis. By way of example, the horizontal offset may be computed as the difference between the sum of the two left quadrant outputs and the sum of the two right quadrant outputs, divided by the total power across all four quadrants, and the vertical offset may be computed analogously using the top and bottom quadrant pairs. The normalization by total power makes the measurement insensitive to variations in the absolute received power level caused by range changes, atmospheric attenuation, or transmitter power fluctuations, isolating the angular alignment information from the overall signal strength. The resulting two-axis offset signal is a continuous, real-time measurement of how far and in which direction the incoming beam has drifted from the optimal alignment reference, and this signal is fed directly into the tracking control loop that computes and applies steering corrections to the beam steering element. Because the quad photodiode produces a continuous analog output that updates at the speed of the detector electronics, the measurement bandwidth is limited only by the photodiode response time and the readout circuit bandwidth, enabling alignment measurements at rates of thousands to millions of samples per second, far exceeding the correction bandwidth required even for the most demanding data center vibration and disturbance environments.

The PAT module uses the two-axis offset signal from position-sensitive detector 404 to drive the closed-loop tracking process described with respect to FIG. 1. During acquisition refinement, the offset signal guides the beam steering element through iterative adjustments that progressively center focused spot 408 on position-sensitive detector 404 until the signal quality metric exceeds the acquisition threshold. During steady-state tracking, the offset signal is continuously monitored and any deviation of focused spot 408 from the center of the detector triggers a steering correction that drives the spot back toward the balanced center position. In an exemplary embodiment, the correction may be computed using a proportional-integral-derivative control algorithm in which the proportional term responds to the current offset, the integral term compensates for sustained drift that the proportional term alone cannot eliminate, and the derivative term anticipates the direction of movement to dampen oscillation and improve step response. In an exemplary embodiment, the offset measurements from position-sensitive detector 404 may be logged as part of the tracking history data used by predictive tracking algorithms to anticipate periodic disturbances and apply preemptive corrections.

In an exemplary embodiment, position-sensitive detector 404 may be a lateral-effect position-sensitive detector rather than a quad photodiode, providing continuous position readout across the entire active area rather than a four-sector differential measurement, which may offer advantages in linearity and resolution for certain deployment configurations. In an exemplary embodiment, position-sensitive detector 404 may be a camera sensor used in conjunction with image analysis software that computes the centroid of focused spot 408 within the captured frame, providing both alignment measurement and the ability to identify and distinguish the partner terminal in a complex scene containing multiple light sources or reflections. In an exemplary embodiment, position-sensitive detector 404 may be used in combination with power monitoring on the communication signal detector, providing a sensor fusion approach in which the spatial offset from the position-sensitive detector and the received power level from the data detector are jointly used to assess alignment quality and compute corrections, yielding a more robust tracking response than either measurement alone.

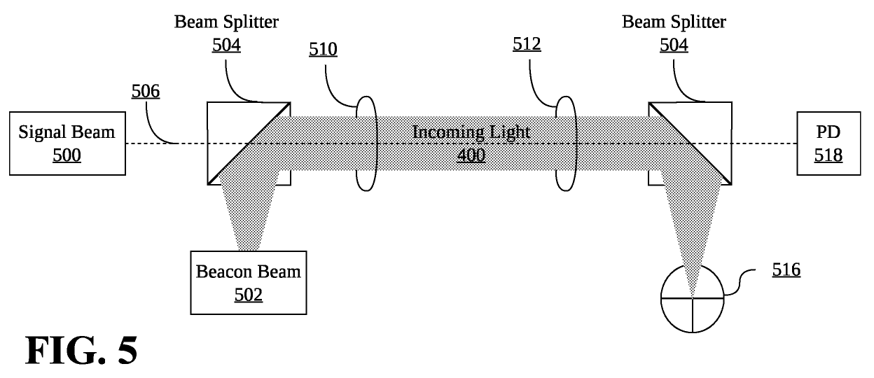

FIG. 5 is a block diagram illustrating an exemplary dual-beam optical architecture that separates the data transmission function and the alignment tracking function onto independent signal and beacon channels. This separation enables continuous evaluation of link alignment quality without interrupting or depending on the communication data stream, and is particularly advantageous in data center deployments where the active tracking system must maintain precise alignment at all times regardless of whether the communication channel is carrying data traffic, is idle, or is in a transitional state between link establishment and steady-state operation.

On the transmit side, a signal beam 500 carries the modulated communication data encoded onto a coherent optical carrier by the transmitter’s laser and modulation subsystem. Signal beam 500 operates at a wavelength selected for the data communication link, and in an exemplary embodiment may be generated by a Small Form-factor Pluggable transceiver device or a dedicated laser and modulator pair as described with respect to the system architectures disclosed herein. A beacon beam 502 is a separate light source that serves as a dedicated spatial reference for alignment tracking. Beacon beam 502 operates at a wavelength distinct from signal beam 500, enabling the two beams to be distinguished and separated by wavelength-selective optical elements at the receiver. Beacon beam 502 may be generated by, by way of example, a light-emitting diode or a laser source, and need not carry high-bandwidth data. In an exemplary embodiment, beacon beam 502 may be an unmodulated continuous-wave emission whose sole function is to provide a stable and constant optical reference for the alignment detector at the receiver. In an exemplary embodiment, beacon beam 502 may be modulated at a low rate to encode control data such as terminal status, coordination commands, or alignment feedback information, serving a dual function as both a spatial reference and a low-bandwidth inter-terminal control channel as described with respect to FIG. 1.

Signal beam 500 and beacon beam 502 are combined into a single co-propagating output by a beam splitter 504 on the transmit side. Beam splitter 504 is an optical element that merges the two beams onto a common optical axis so that they travel together through the downstream transmit optics and across the free space path to the receiver. Because signal beam 500 and beacon beam 502 operate at different wavelengths, beam splitter 504 may be implemented as a dichroic beam splitter that reflects one wavelength while transmitting the other, or as a broadband beam splitter that combines the two beams by amplitude division. In an exemplary embodiment, beam splitter 504 may alternatively be a polarization beam splitter where signal beam 500 and beacon beam 502 are distinguished by polarization state rather than wavelength. The combined beam 506 exits through output optics 510, which collimate and direct the combined beam across the free space gap between the transmitting and receiving terminals. Output optics 510 may be a single lens, a multi-element lens assembly, or any suitable collimating optic designed to produce the beam diameter and divergence appropriate for the link range within the data center. Because signal beam 500 and beacon beam 502 share the same transmit optics and the same beam steering element, any steering correction applied to maintain alignment of the beacon also maintains alignment of the signal, and vice versa, ensuring that the two channels remain inherently coaligned throughout the optical path.

The combined beam propagates across the data center as incoming light 400 and is collected by input optics 512 at the receiving terminal. Input optics 512 gather incoming light 400 and focus it into the receive optical path, where a second beam splitter 504, functioning as a beacon filter, separates the signal and beacon components by passing light at the signal wavelength while rejecting light at the beacon wavelength based on the same distinguishing property used to combine them at the transmitter. In the wavelength-division implementation, the receive-side beam splitter 504 passes light at the signal wavelength toward a photodiode 518 while reflecting light at the beacon wavelength toward a position-sensitive detector 516. In the polarization-division implementation, beam splitter 504 separates the two beams based on their orthogonal polarization states. The separation ensures that beacon light does not interfere with data reception at photodiode 518 and that the high-power modulated signal does not corrupt the alignment measurement at position-sensitive detector 516.

Position-sensitive detector 516 receives the isolated beacon component of the incoming light and measures the spatial position of the focused beacon spot on its active surface, as described in detail with respect to FIG. 4. Because beacon beam 502 is a dedicated, continuous optical reference that is independent of the data traffic carried by signal beam 500, position-sensitive detector 516 produces a stable and uninterrupted alignment measurement regardless of the modulation state, data rate, encoding scheme, or traffic load on the communication channel. This decoupling is particularly valuable in data center environments where communication links may experience periods of variable traffic, idle states between data bursts, or transitions between different data rates and protocols, any of which could introduce amplitude or timing variations on the signal channel that would complicate alignment measurements if the tracking system relied solely on the communication signal for spatial feedback. The PAT module uses the alignment information from position-sensitive detector 516 to continuously compute and apply steering corrections that keep the beacon centered on the detector, and because the beacon and signal share a common optical path, centering the beacon simultaneously ensures optimal alignment of the signal onto photodiode 518.

Photodiode 518 receives the isolated signal component of the incoming light and converts the modulated optical signal back into an electrical data stream representing the originally transmitted data. Photodiode 518 may be, by way of example, an InGaAs photodiode, an avalanche photodiode, or another high-speed detector technology selected based on the operating wavelength and the data rate requirements of the communication link. Because beam splitter 504 on the receive side has removed the beacon component before the light reaches photodiode 518, the data detector sees only the modulated communication signal, free from any optical interference from the beacon that could degrade signal-to-noise ratio or introduce bit errors. The electrical output of photodiode 518 is processed by receiver control electronics that decode the data and deliver it to the host network infrastructure.

In an exemplary embodiment, the dual-beam architecture may be implemented in both directions of a bidirectional link, with each terminal incorporating its own signal beam, beacon beam, beam splitters, position-sensitive detector, and data photodiode, enabling each terminal to independently and continuously track the alignment of its incoming link while transmitting both data and a beacon reference to its partner. In an exemplary embodiment, the beacon channel may be configured with a wider divergence than the signal channel to increase the probability of detection during the initial acquisition phase, while the signal channel maintains a narrow divergence for maximum power density and long-range data transmission. In an exemplary embodiment, the PAT module may monitor both the spatial offset from position-sensitive detector 516 and the received power or bit error rate from photodiode 518 simultaneously, fusing the two measurements to produce a more robust assessment of link quality than either source alone. In an exemplary embodiment, the alignment and data systems may share additional optical elements beyond the beam splitters and transmit/receive optics described herein, or may be implemented as entirely independent subsystems with no elements in common, depending on the design requirements of the specific deployment.

In an exemplary embodiment, beacon beam 502 may be configured to serve a dual function as both a spatial reference for alignment tracking and a low-bandwidth control communication channel between the transmitting and receiving terminals. Rather than emitting a continuous, unmodulated signal whose sole purpose is to provide a detectable angular reference, beacon beam 502 may be modulated by the transmitter control electronics to encode low-rate control data onto the beacon emission. The control data represents operational information intended for the partner terminal's control system and is distinct from the high-rate user data carried by signal beam 500 on the communication channel. By way of example, the control data may convey status messages such as whether the transmitting terminal is powered on and operational, whether the transmitting terminal is currently executing a beam steering adjustment and requires the receiving terminal to hold its current alignment, whether the transmitting terminal has detected a fault or degraded condition, or whether the transmitting terminal is preparing to transition from acquisition mode to data transmission mode. The modulation applied to beacon beam 502 for the purpose of encoding control data may be, by way of example, simple on-off keying, pulse position modulation, or amplitude modulation at a baud rate that is orders of magnitude lower than the data rate of signal beam 500. Because the control messages are short, infrequent, and limited in content, the modulation rate may be on the order of tens to hundreds of bits per second, which is readily achievable using the same light source that generates beacon beam 502 without requiring additional drive circuitry or optical components. The low modulation rate also ensures that the spatial reference function of beacon beam 502 is not materially impaired, as position-sensitive detector 516 can still derive angular position information from the time-averaged intensity distribution of the beacon even while the beacon is being modulated with control data.

On the receive side, position-sensitive detector 516 serves as a beacon detector that performs two simultaneous functions: measuring the spatial characteristics of the incoming beacon for alignment purposes, and demodulating the low-rate control data encoded onto the beacon signal. Because position-sensitive detector 516, functioning as beacon detector, is already configured to measure optical intensity, it is inherently capable of detecting the intensity variations introduced by the control data modulation. In an exemplary embodiment, a dedicated beacon detector separate from the position-sensitive detector may be employed to receive the beacon signal and extract the control data, allowing the alignment measurement and control data demodulation functions to be performed by independent detection elements optimized for their respective tasks. Receiver control electronics extract the control data from the electrical signal produced by beacon detector by applying appropriate filtering and demodulation routines to separate the low-rate control information from the spatial alignment measurements. Because position-sensitive detector 516 is already configured to measure optical intensity, it is inherently capable of detecting the intensity variations introduced by the control data modulation. Receiver control electronics extract the control data from the electrical signal produced by position-sensitive detector 516 by applying appropriate filtering and demodulation routines to separate the low-rate control information from the spatial alignment measurements. In a bidirectional system where the receiving terminal also incorporates a beacon light source, the control channel operates in both directions, enabling each terminal to communicate its status and coordination commands to its partner using only the beacon channels already present in the system. This eliminates the need for any external communication path between terminals, including radio frequency links, wired cables, or access to the end-user data network, all of which may be unavailable, impractical, or prohibited in the data center deployment environment. By embedding all inter-terminal coordination into the beacon channel, the system achieves fully autonomous operation in which every exchange of information between terminals, both the high-rate user data on the communication channel and the low-rate control data on the beacon channel, occurs exclusively over optical paths that are already part of the system architecture. This dual-function beacon approach supports the full range of coordination activities required for autonomous acquisition, active tracking, self-healing, and reconfiguration without introducing any additional hardware, communication infrastructure, or security exposure beyond what is already present.

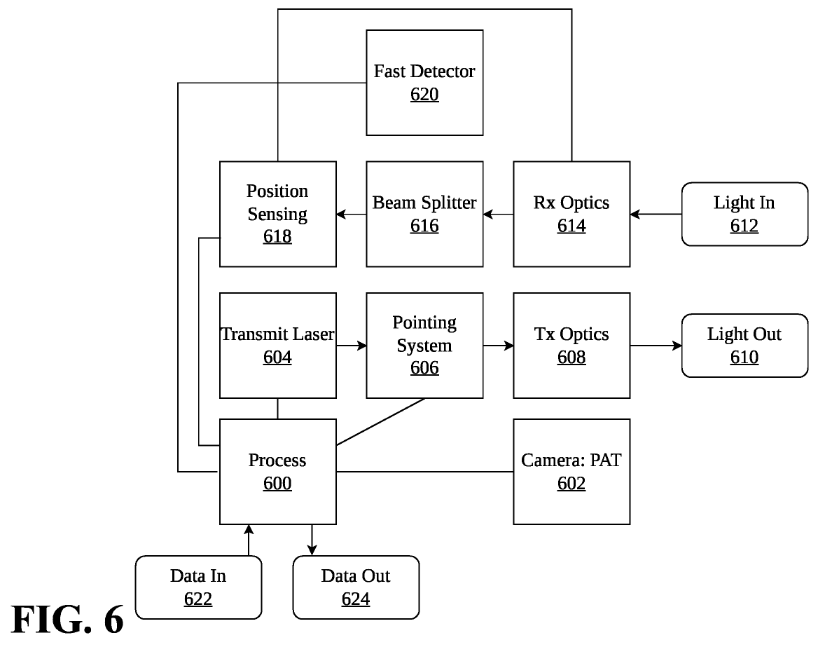

FIG. 6 is a block diagram illustrating an exemplary complete terminal architecture for a single optical terminal in a data center free space optical communication system, showing the integration of the transmit, receive, alignment, and control subsystems into a unified system under the coordination of a central processor. This figure represents one exemplary implementation of optical terminal 104 or optical terminal 106 as described with respect to FIG. 1, with each of the functional elements depicted in the preceding figures integrated into a single terminal capable of simultaneously transmitting data, receiving data, and actively maintaining alignment with a partner terminal.

A processor 600 serves as the central controller for the terminal, coordinating all transmit, receive, and alignment functions. Processor 600 receives and processes inputs from multiple subsystems, encodes outgoing data for optical transmission, decodes incoming data from the optical receiver, computes steering corrections for the pointing system, and manages timing and synchronization across all terminal functions. Processor 600 may be implemented as a microprocessor, a microcontroller, a field-programmable gate array, a digital signal processor, or any combination thereof, depending on the computational throughput and real-time response requirements of the deployment. In an exemplary embodiment, processor 600 may execute machine learning or artificial intelligence routines that analyze historical tracking data, environmental sensor inputs, and link performance trends to build predictive models of alignment drift and apply preemptive corrections before signal quality degrades, as described with respect to FIG. 1. In an exemplary embodiment, processor 600 may communicate with a centralized network controller over a management interface to receive link assignment instructions, report link status information, and execute reconfiguration commands as part of the network-level orchestration method disclosed herein.

In an exemplary embodiment, processor 600 registers the terminal with a network controller upon activation by reporting the terminal's position within the data center facility, its orientation relative to the facility coordinate frame, its available steering range defining the angular region over which the beam steering element can direct the optical beam, and its operational status indicating whether the terminal is available for link assignment. The network controller maintains a network topology map comprising all registered terminals and, where applicable, relays, and uses the reported registration parameters to compute link topologies that assign terminal pairings based on bandwidth requirements, redundancy targets, and line-of-sight availability between registered terminals. Upon receiving a link assignment instruction from the network controller designating a specific partner terminal, processor 600 initiates the acquisition sequence to establish an optical link with the designated partner. During the established link, processor 600 periodically reports link status information to the network controller, including the current signal quality metric, active connection status, and any anomalies detected by the tracking or self-healing processes. The network controller aggregates status reports from all registered terminals to maintain a real-time view of aggregate network health across the deployment. When a reconfiguration trigger is detected, which may comprise a link failure event that cannot be resolved locally, a change in bandwidth demand, the addition or removal of a terminal, or an operator-issued reconfiguration command, the network controller computes an updated link topology and issues reconfiguration instructions to affected terminals. Upon receiving a reconfiguration instruction directing the terminal to terminate its current link and initiate the acquisition sequence with a reassigned partner, processor 600 gracefully terminates the current connection, updates its target partner information, and begins the acquisition sequence for the new assignment.

A data in interface 622 receives an electronic data stream from the host computing equipment to be transmitted across the optical link. Data in interface 622 may accept data from any standard network interface including, by way of example, an Ethernet connection, a fiber channel interface, or any protocol-agnostic data source. Processor 600 receives the incoming data stream from data in interface 622, encodes it into a format suitable for optical transmission, and drives the transmit laser accordingly. A data out interface 624 delivers the recovered data stream to the host computing equipment after processor 600 has decoded the optical signal received from the partner terminal. Data out interface 624 provides the output in a format compatible with the receiving network infrastructure. The system is protocol agnostic, capable of transmitting any standard data format without requiring protocol-specific hardware or conversion at the optical layer, and in an exemplary embodiment may support data rates compatible with standard Ethernet speeds by incorporating appropriate transceiver devices at data in interface 622 and data out interface 624.

On the transmit side, a transmit laser 604 generates a modulated optical beam encoding the data stream received from processor 600. Transmit laser 604 may operate at any suitable wavelength, and in an exemplary embodiment operates in the infrared spectrum at a wavelength and power level selected to comply with applicable eye safety standards for deployment in occupied data center facilities. Processor 600 controls the modulation of transmit laser 604 to encode data onto the optical carrier by varying one or more properties of the light, such as intensity, phase, or polarization, in accordance with the data stream. The modulated beam from transmit laser 604 is directed into a pointing system 606, which steers the beam toward the partner terminal. Pointing system 606 is the beam steering element of the terminal and may be implemented using any of the steering technologies described herein, including galvanometer-driven mirrors as described with respect to FIG. 2, a MEMS mirror, an optical phased array, a liquid crystal spatial light modulator, a metasurface, or any other suitable mechanism. Processor 600 commands pointing system 606 with angular position instructions derived from the alignment feedback loop, and pointing system 606 translates those instructions into the physical beam direction. The steered beam passes through transmit optics 608, which collimate and shape the beam for free space propagation, and exits the terminal as light out 610 directed toward the partner terminal across the data center.

On the receive side, light in 612 arrives at the terminal from the partner terminal and is collected by receiver optics 614. Receiver optics 614 gather the incoming light and focus it into the receive optical path. In an exemplary embodiment, receiver optics 614 may incorporate a beam steering element that is independently steerable by processor 600, enabling the receive field of view to be actively adjusted to optimize collection of the incoming signal. The focused light passes into a beam splitter 616, which divides the received optical signal between two separate detection paths. Beam splitter 616 directs a portion of the incoming light to a position-sensitive detector 618 and routes the remaining light to a fast detector 620. The split ratio may be selected to allocate sufficient optical power to position-sensitive detector 618 for reliable alignment measurement while preserving the majority of the received power for data detection at fast detector 620. In an exemplary embodiment where a dedicated beacon channel is employed as described with respect to FIG. 5, beam splitter 616 may be a wavelength-selective element that separates the beacon and signal components rather than dividing the incoming light by amplitude.

Position-sensitive detector 618 measures the spatial offset of the incoming beam relative to the detector center, as described in detail with respect to FIG. 4, producing a two-axis alignment signal that is fed back to processor 600. Processor 600 uses this alignment signal to compute steering corrections that are applied to pointing system 606 to maintain the transmitted beam aimed at the partner terminal, and in an exemplary embodiment may also apply corrections to receiver optics 614 to optimize the receive alignment independently. This closed feedback loop from position-sensitive detector 618 through processor 600 to pointing system 606 is the core mechanism by which the terminal achieves continuous active tracking and maintains the alignment precision required for reliable data transmission in the presence of the vibration, thermal drift, and airflow disturbances characteristic of the data center environment. Fast detector 620 is a high-speed, high-sensitivity photodetector that converts the modulated optical signal back into an electrical data stream. Fast detector 620 may be, by way of example, an InGaAs photodiode, an avalanche photodiode, or another detector technology selected for the bandwidth and sensitivity required to recover the transmitted data at the operating data rate. The electrical output of fast detector 620 is delivered to processor 600, which decodes the data and outputs it through data out interface 624.

A camera 602 actively monitors the scene in front of the terminal and provides image data to processor 600 for use in the pointing, acquisition, and tracking process. Camera 602 captures frames of the environment including the partner terminal and any identifiable marks, beacons, or visual features that can be located through image analysis software executed by processor 600. During initial acquisition, camera 602 may provide coarse directional information by identifying the location of the partner terminal in the camera frame and computing the angular bearing needed to point toward it, reducing the angular search region that pointing system 606 must scan and accelerating the acquisition process. During steady-state tracking, camera 602 provides a supplementary alignment measurement that operates independently of the position-sensitive detector path, giving processor 600 an additional source of spatial information that can be fused with the electrical feedback from position-sensitive detector 618 to improve tracking robustness. In an exemplary embodiment, camera 602 may also detect environmental changes in the data center such as the presence of personnel, equipment being moved, or obstructions entering the beam path, enabling processor 600 to anticipate disruptions and preemptively enter a hold state or initiate a directed search before the signal quality metric falls below the disruption threshold.

The architecture of FIG. 6 achieves the high-availability tracking required for data center deployments by providing processor 600 with multiple independent and complementary sources of alignment information: the spatial offset measurement from position-sensitive detector 618, the image analysis data from camera 602, the received power and data quality metrics from fast detector 620, and in an exemplary embodiment, status and alignment data communicated from the partner terminal over an auxiliary or beacon-based control channel. Processor 600 fuses these inputs using sensor fusion techniques to produce a composite alignment assessment that is more robust and reliable than any single measurement source alone. The system can adapt on both the transmit and receive sides simultaneously, with processor 600 independently commanding pointing system 606 for the outgoing beam and receiver optics 614 for the incoming beam. This multi-input, dual-sided correction architecture, combined with the predictive modeling and self-healing capabilities executed by processor 600, provides the level of autonomous, continuous alignment control necessary to meet five-nines availability requirements in data center free space optical links.

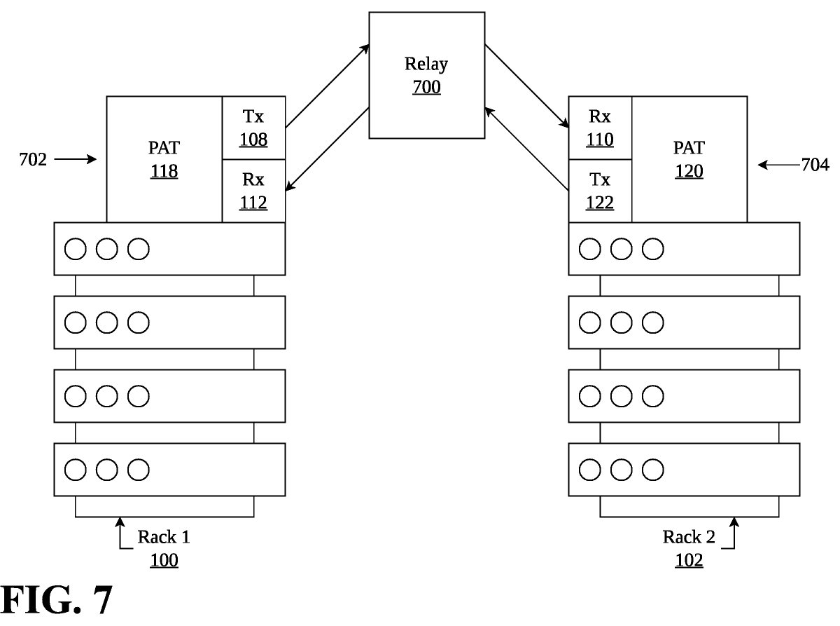

FIG. 7 is a block diagram illustrating an exemplary relay-assisted system architecture for a free space optical communication link between two computing equipment racks in a data center environment where a direct line-of-sight path between the two rack-mounted optical terminals is unavailable or impractical. Free space optical communication requires an unobstructed optical path between the transmitter and receiver, and in data center facilities the direct path between two rack-mounted terminals may be blocked by overhead cable trays, cooling ductwork, structural columns, equipment being temporarily staged in an aisle, or the physical geometry of the facility layout itself. The relay-assisted architecture overcomes this line-of-sight constraint by routing the optical beam through an intermediate relay that redirects the light between the two terminals along a path that avoids the obstruction.

A first rack 100 houses a first optical terminal 702 that includes a transmitter 108, a receiver 112, and a PAT module 118, as described with respect to FIGS. 1 and 6. A second rack 102 houses a second optical terminal 704 that includes a receiver 110, a transmitter 122, and a PAT module 120. Rather than directing the optical beam along a direct horizontal path between first optical terminal 702 and second optical terminal 704, both terminals direct their beams toward a relay 700 positioned at a location that has line-of-sight to both terminals. In the exemplary arrangement shown, relay 700 is positioned above and between the two racks, such as on a ceiling mount, an overhead beam, or a bracket attached to the facility structure, where it can see down to both rack-top terminals without obstruction.

Relay 700 receives the optical beam from first optical terminal 702 and redirects it toward second optical terminal 704, and simultaneously receives the optical beam from second optical terminal 704 and redirects it toward first optical terminal 702, enabling full-duplex bidirectional communication through the relay. In its simplest implementation, relay 700 may be a passive optical element such as a mirror or a pair of mirrors arranged to redirect the beam along the required angular path between the two terminals. A passive mirror relay introduces no electronic components, requires no electrical power, and adds no processing latency to the link, serving purely as a geometric redirection of the optical path. In an exemplary embodiment, relay 700 may incorporate a more complex optical system such as a lens assembly that collects, refocuses, and redirects the beam to compensate for divergence losses accumulated over the two-segment path, improving the link budget in configurations where the total path length through the relay exceeds the range that the terminal optics were designed to support in a single direct hop. In an exemplary embodiment, relay 700 may be an active relay that receives the optical signal, converts it to an electrical signal, regenerates and optionally amplifies it, and retransmits it as a fresh optical signal toward the destination terminal. An active relay of this type functions as an optical-electrical-optical repeater that restores the signal to full strength regardless of the path loss accumulated on each segment, enabling relay-assisted links over distances or through atmospheric conditions that would exceed the link budget of a single passive redirection. An active relay may also perform protocol-level functions such as error detection and retransmission, enabling each segment of the relay-assisted link to be independently managed for quality of service.

PAT module 118 on first optical terminal 702 and PAT module 120 on second optical terminal 704 each acquire and track relay 700 rather than tracking the partner terminal directly. The acquisition and tracking processes operate in the same manner as described with respect to FIG. 1, with each PAT module scanning its angular search region to locate relay 700, refining alignment based on feedback from a spatially sensitive detector, and continuously maintaining alignment through closed-loop correction during steady-state operation. In an exemplary embodiment where relay 700 is a passive mirror, each terminal tracks the reflected image of the partner terminal’s beacon or communication signal as it appears at the relay, and the self-healing recovery sequence described with respect to FIG. 1 applies to the terminal-to-relay segment of the link. In an exemplary embodiment where relay 700 is an active relay, relay 700 may itself incorporate PAT modules that independently track each terminal, creating two independently managed link segments that can each acquire, track, and self-heal autonomously.

In an exemplary embodiment, multiple relays may be chained to route an optical link around multiple obstructions or through complex facility geometries, with each relay redirecting the beam to the next relay or to the destination terminal in succession. In an exemplary embodiment, relay 700 may be a multi-port relay capable of simultaneously serving more than two terminals, functioning as an optical hub or switch point that redirects beams between multiple terminal pairs. A multi-port relay may incorporate multiple independent mirror surfaces, beam steering elements, or beam splitting and combining optics to maintain simultaneous optical paths between several terminals. In an exemplary embodiment, the network controller described herein may manage relay assignments as part of the topology computation, treating relays as intermediate nodes in the link topology map and selecting relay-assisted paths when direct line-of-sight paths between designated terminal pairs are unavailable.

The relay-assisted architecture enables the construction of mesh networks of optical terminals within a data center, providing multiple potential paths between any two endpoints and adding a layer of redundancy to the optical interconnect fabric. If a direct link between two terminals is disrupted by a persistent obstruction or equipment change, the network controller may reroute the connection through one or more relays to maintain connectivity without requiring physical relocation of the terminals. The combination of beam steering at each terminal, relay-assisted routing through intermediate nodes, and centralized topology management by the network controller creates a flexible, reconfigurable optical network that can adapt to the physical constraints and evolving layout of the data center facility while maintaining the low latency, high bandwidth, electromagnetic immunity, and protocol agnosticism inherent in free space optical communication.

In an exemplary embodiment, a network controller manages a plurality of optical terminals within the data center, coordinating link assignments and monitoring aggregate network health across the deployment. Each terminal registers with the network controller upon activation, reporting its position, orientation, available steering range, and operational status. The network controller maintains a network topology map comprising all registered terminals and, where applicable, relays, and computes an initial link topology that assigns terminal pairings and communication paths based on bandwidth requirements, redundancy targets, and line-of-sight availability. Link assignment instructions are issued to each terminal, providing the designated partner identity and any wavelength or protocol parameters needed to establish a compatible connection, whereupon each terminal autonomously executes its acquisition sequence to establish the assigned link.

During steady-state operation, the network controller collects link status information from each terminal, including current signal quality metrics, active connection status, and any anomalies detected by the terminal's tracking or self-healing processes, and aggregates these reports into a unified view of network health and utilization. When a reconfiguration trigger is detected, which may comprise a link failure that cannot be resolved locally, a change in bandwidth demand, the addition or removal of a terminal, or an operator-issued reconfiguration command, the network controller computes an updated link topology that reassigns terminal pairings to satisfy current requirements while minimizing disruption to active links that are operating satisfactorily. Reconfiguration instructions are issued only to affected terminals, which gracefully terminate their current connections and initiate acquisition sequences with their reassigned partners. The network controller verifies that all reassigned links have been successfully established and that aggregate network performance meets predetermined thresholds, flagging unsuccessful assignments for retry or alternative routing. This centralized orchestration layer transforms the collection of individual point-to-point optical links into a managed, reconfigurable optical network fabric that can adapt in real time to the evolving connectivity requirements of the data center.

### Description of Method Aspects

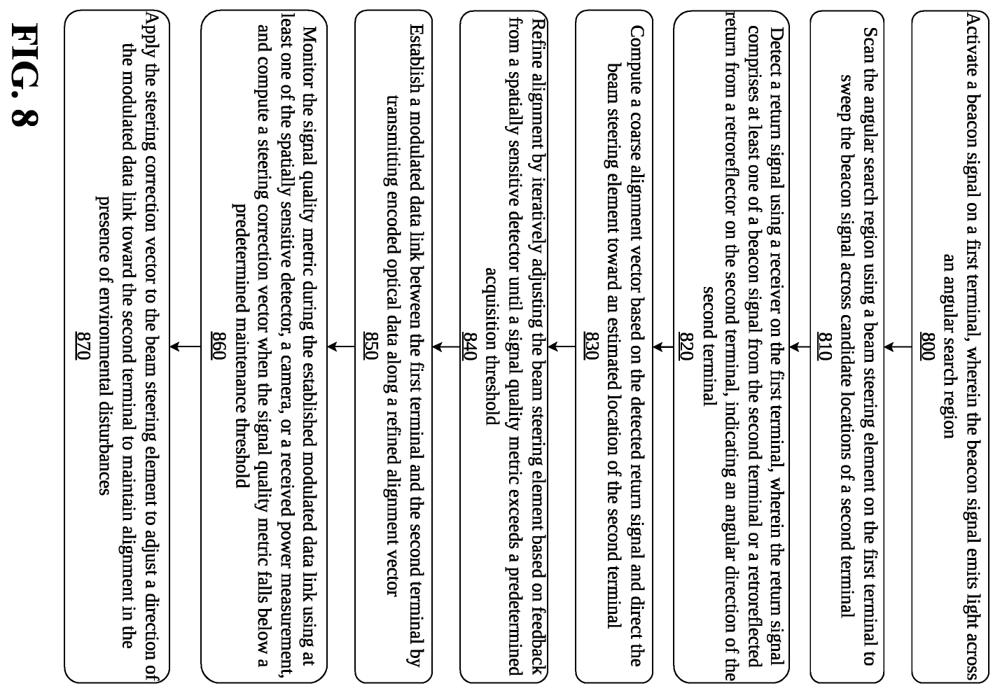

FIG. 8 is a flow diagram illustrating an exemplary method for establishing and maintaining a free space optical communication link between a first terminal and a second terminal within a data center environment. In a first step 800, a beacon signal is activated on a first terminal, wherein the beacon signal emits light across an angular search region. The beacon signal is a dedicated optical emission configured with sufficient angular coverage and power to be detectable by a partner terminal that has not yet established precise alignment. The angular search region may be defined based on prior knowledge of the deployment geometry or may encompass the full field of regard of the terminal to accommodate unknown partner locations.

In a step 810, the angular search region is scanned using a beam steering element on the first terminal to sweep the beacon signal across candidate locations of a second terminal. The scan follows a predetermined trajectory, such as a raster or spiral pattern, designed to ensure complete coverage of the search region within an acceptable time window. The scan rate balances the tradeoff between search speed and the dwell time required at each angular position for reliable detection by the partner terminal.

In a step 820, a return signal is detected using a receiver on the first terminal, wherein the return signal comprises at least one of a beacon signal from the second terminal or a retroreflected return from a retroreflector on the second terminal, indicating an angular direction of the second terminal. Detection may occur while the first terminal is actively scanning or while it is dwelling at a fixed position within the search region. When the return signal originates from a retroreflector, alignment is detected without requiring an active response from the second terminal, enabling acquisition in configurations where no side-channel communication path has yet been established.

In a step 830, a coarse alignment vector is computed based on the detected return signal and the beam steering element is directed toward an estimated location of the second terminal. The coarse alignment vector represents an initial angular correction sufficient to bring the transmitted beam into the approximate vicinity of the partner terminal, reducing the remaining angular uncertainty from the full search region down to a narrow cone centered on the second terminal.

In a step 840, alignment is refined by iteratively adjusting the beam steering element based on feedback from a spatially sensitive detector until a signal quality metric exceeds a predetermined acquisition threshold. Each iteration measures the residual angular offset between the current beam direction and the optimal alignment, applies a corrective adjustment, and re-evaluates the resulting signal quality. The acquisition threshold defines the minimum alignment precision at which the link is considered sufficiently stable to support data transmission.

In a step 850, a modulated data link is established between the first terminal and the second terminal by transmitting encoded optical data along a refined alignment vector. The transition from beacon-only operation to data transmission may occur as an instantaneous switch or as a gradual handoff in which the beacon and data signals operate concurrently during an overlap period to ensure alignment is maintained throughout the changeover.

In a step 860, the signal quality metric is monitored during the established modulated data link using at least one of the spatially sensitive detector, a camera, or a received power measurement, and a steering correction vector is computed when the signal quality metric falls below a predetermined maintenance threshold. Multiple alignment measurement sources may be monitored simultaneously and combined to provide a more robust assessment of link health than any single measurement alone. The maintenance threshold is set with sufficient margin above the minimum signal level required for reliable data transmission so that corrective action is initiated while the link still has quality headroom to sustain uninterrupted communication during the correction process.

In a step 870, the steering correction vector is applied to the beam steering element to adjust a direction of the modulated data link toward the second terminal to maintain alignment in the presence of environmental disturbances. The magnitude and speed of the applied correction may be scaled based on the severity of the detected deviation, and the monitoring and correction cycle repeats at a predetermined update rate that may be adaptively adjusted based on observed link stability. In an exemplary embodiment, tracking history data comprising recent steering corrections and signal quality trends may be stored and used to compute predictive adjustments that compensate for periodic or anticipated disturbances prior to degradation of the signal quality metric below the maintenance threshold.

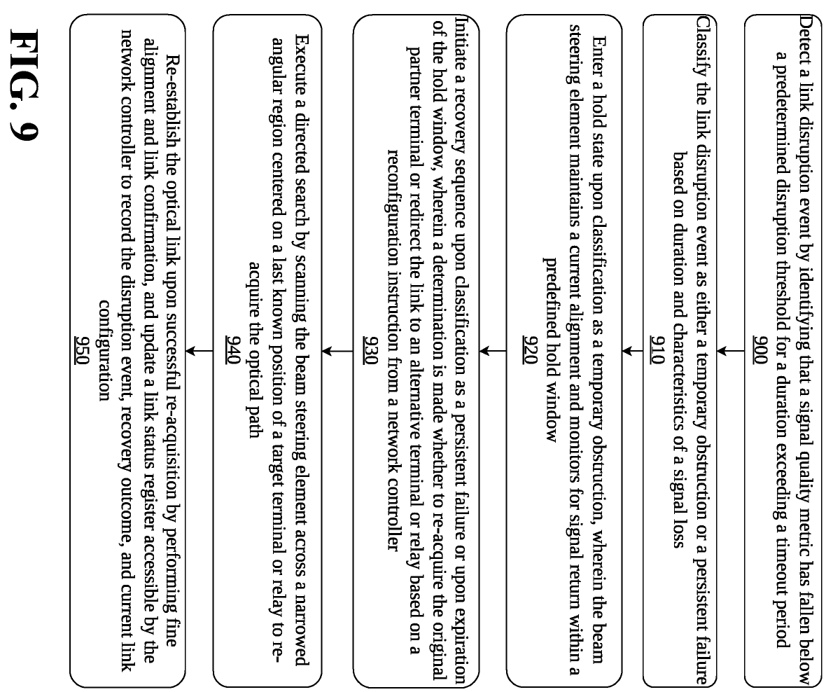

FIG. 9 is a flow diagram illustrating an exemplary method for self-healing recovery and relay-assisted reconfiguration of a free space optical communication link within a data center environment. In a first step 900, a link disruption event is detected by identifying that a signal quality metric has fallen below a predetermined disruption threshold for a duration exceeding a timeout period. The disruption threshold is set below the maintenance threshold used during normal active tracking, representing a level of signal degradation beyond what the tracking correction loop can compensate for. The timeout period prevents momentary signal fluctuations caused by transient events, such as brief vibration impulses or a person momentarily passing near the beam path, from being mischaracterized as true disruptions.

In a step 910, the link disruption event is classified as either a temporary obstruction or a persistent failure based on duration and characteristics of a signal loss. Classification may consider factors such as the rate at which the signal degraded, whether any residual signal remains at a reduced level, and whether the pattern of loss is consistent with known obstruction profiles. By way of example, a rapid and complete loss of signal followed by partial signal return within a short interval may be classified as a temporary obstruction, while a gradual degradation that stabilizes below the disruption threshold may indicate a persistent mechanical drift or environmental change requiring active recovery.

In a step 920, a hold state is entered upon classification as a temporary obstruction, wherein the beam steering element maintains a current alignment and monitors for signal return within a predefined hold window. The hold state preserves the last known good alignment so that when the obstruction clears, the link can resume immediately without requiring a full re-acquisition sequence. The hold window defines the maximum duration for which the current alignment will be maintained before the disruption is reclassified as a persistent failure. In an exemplary embodiment, the hold window duration may be configurable based on the deployment environment, with shorter windows for time-critical links and longer windows for environments where temporary obstructions are frequent and expected to resolve on their own.

In a step 930, a recovery sequence is initiated upon classification as a persistent failure or upon expiration of the hold window, wherein a determination is made whether to re-acquire the original partner terminal or redirect the link to an alternative terminal or relay based on a reconfiguration instruction from a network controller. This decision point enables the recovery process to serve both restoration and reconfiguration functions depending on operational needs. In the absence of a reconfiguration instruction, the default behavior is to attempt re-acquisition of the original partner at its last known position. When a reconfiguration instruction is present, the recovery sequence targets the designated alternative terminal or relay instead, enabling dynamic rerouting of communication paths in response to changing network requirements, the permanent loss of a partner terminal, or the availability of a relay-assisted path that circumvents the obstruction.

In a step 940, a directed search is executed by scanning the beam steering element across a narrowed angular region centered on a last known position of a target terminal or relay to re-acquire the optical path. The directed search covers a reduced angular region compared to the full acquisition search, exploiting prior knowledge of where the target was last successfully tracked to accelerate recovery. The search region may be sized based on the expected range of displacement since the link was lost, accounting for factors such as the elapsed time during the hold state and the maximum expected drift rate of the target. In an exemplary embodiment, the directed search may progressively expand the angular search region if the initial narrowed search does not locate the target within a predetermined number of scan cycles, eventually widening to a full acquisition search if the target has moved significantly from its last known position.

In a step 950, the optical link is re-established upon successful re-acquisition by performing fine alignment and link confirmation, and a link status register accessible by the network controller is updated to record the disruption event, recovery outcome, and current link configuration. Fine alignment follows the same iterative refinement process used during initial acquisition, ensuring that the re-established link meets the same quality standards as a newly formed connection. The recorded information may include the time and duration of the disruption, the classification assigned to the event, whether recovery was successful, and the identity of the terminal or relay to which the link is now connected. This historical record enables trend analysis over time, allowing patterns of recurring disruptions to be identified and addressed through preventive measures such as repositioning terminals, adjusting beam paths to avoid known obstruction zones, or provisioning redundant links across routes that have demonstrated higher failure rates.

### Hardware Architecture

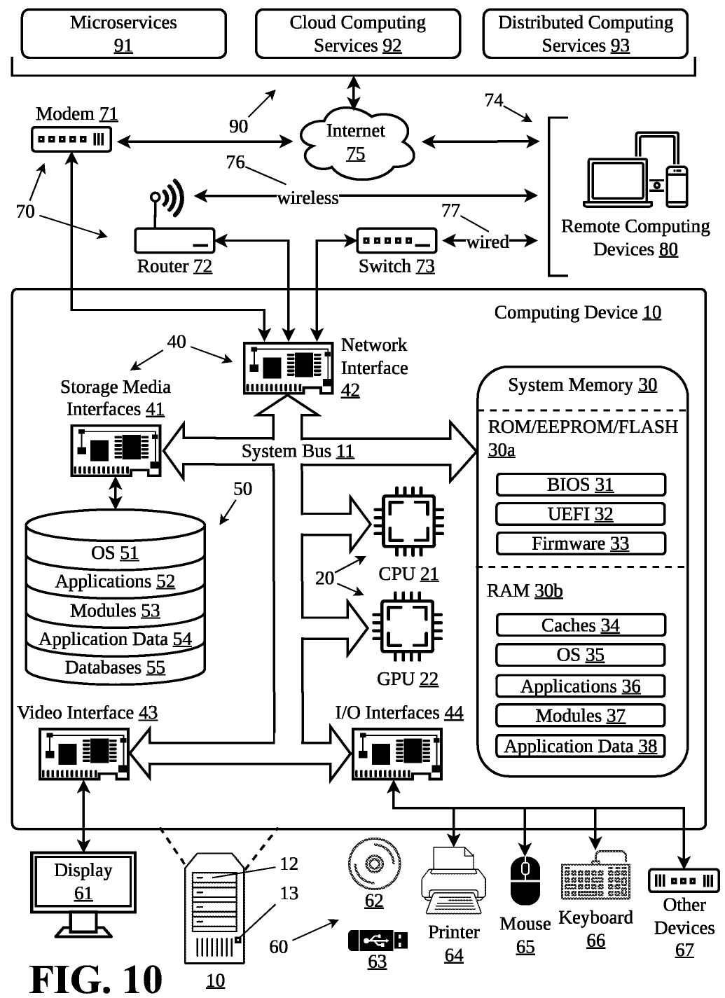

FIG. 10 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI) 32, which is a modern replacement for BIOS that supports larger hard drives, faster boot times, more security features, and provides native support for graphics and mouse cursors. Non-volatile memory 30a may also be used to store firmware 33 comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories 34 which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. An optical communication system for a data center environment comprising:
a first terminal comprising a light source configured to generate a modulated optical signal encoding a data stream, a beam steering element configured to direct the modulated optical signal through free space toward a second terminal, and a controller configured to command the beam steering element;
a second terminal comprising collection optics configured to receive the modulated optical signal from the first terminal, a detector configured to convert the received modulated optical signal into an electrical data stream, and a spatially sensitive detector configured to generate alignment information indicative of an angular offset between the modulated optical signal and the second terminal;
a pointing, acquisition, and tracking system configured to perform an acquisition sequence in which the beam steering element scans an angular search region to locate the second terminal and iteratively refines alignment based on the alignment information until a signal quality metric exceeds a predetermined acquisition threshold; and
a feedback system configured to continuously monitor the signal quality metric during an established communication link and to compute and apply steering corrections to the beam steering element to maintain alignment between the first terminal and the second terminal in the presence of environmental disturbances.

2. The optical communication system of claim 1, wherein the first terminal and the second terminal are each mounted on or adjacent to a computing equipment rack within a data center facility, and wherein the light source operates at a wavelength and power level selected to comply with applicable eye safety standards for deployment in an occupied facility.

3. The optical communication system of claim 1, wherein the beam steering element comprises at least one of a microelectromechanical systems mirror, an optical phased array, a liquid crystal spatial light modulator, a metasurface, a digital micromirror device, an acousto-optic modulator, an electro-optic modulator, a galvanometer-driven mirror, a Risley prism, or a liquid lens.

4. The optical communication system of claim 1, wherein the first terminal further comprises a beacon light source configured to emit a beacon signal at a wavelength distinct from the modulated optical signal, and the second terminal further comprises a beacon filter configured to pass light at the beacon wavelength while rejecting light at the wavelength of the modulated optical signal, wherein the pointing, acquisition, and tracking system performs the acquisition sequence based on the beacon signal independently of the modulated optical signal.

5. The optical communication system of claim 4, wherein the beacon light source is further configured to modulate the beacon signal to encode control data for communication to the second terminal, and wherein the second terminal further comprises a beacon detector configured to receive the beacon signal and to extract the control data from the beacon signal, wherein the control data and the alignment information are communicated between the first terminal and the second terminal without requiring a radio frequency link or a wired data connection between the first terminal and the second terminal.

6. The optical communication system of claim 1, wherein the second terminal further comprises a retroreflector configured to return incident light back toward the first terminal, and wherein the pointing, acquisition, and tracking system is configured to detect a retroreflected return at the first terminal during the acquisition sequence to determine an angular direction of the second terminal.

7. The optical communication system of claim 1, wherein the first terminal further comprises a Small Form-factor Pluggable transceiver device configured to generate the modulated optical signal and output the modulated optical signal through a fiber optic port, and transmit optics configured to receive the modulated optical signal from the fiber optic port and produce a beam directed onto the beam steering element.

8. The optical communication system of claim 1, wherein the feedback system is further configured to:
detect a link disruption event when the signal quality metric falls below a predetermined disruption threshold for a duration exceeding a timeout period;
classify the link disruption event as either a temporary obstruction or a persistent failure;
enter a hold state maintaining a current alignment of the beam steering element upon classification as a temporary obstruction; and
initiate a recovery sequence comprising a directed search across a narrowed angular region centered on a last known position of the second terminal upon classification as a persistent failure or upon expiration of the hold state.

9. The optical communication system of claim 1, further comprising a network controller in communication with a plurality of terminals including the first terminal and the second terminal, wherein the network controller is configured to compute a link topology assigning terminal pairings, issue link assignment instructions directing each terminal to initiate the acquisition sequence with a designated partner terminal, and issue reconfiguration instructions to reassign terminal pairings in response to a reconfiguration trigger.

10. The optical communication system of claim 1, further comprising a relay positioned at a location having line-of-sight to both the first terminal and the second terminal, wherein the first terminal and the second terminal each direct their respective modulated optical signals toward the relay, and the relay redirects the modulated optical signals between the first terminal and the second terminal.

11. A method for establishing and maintaining a free space optical communication link between a first terminal and a second terminal, the method comprising the steps of:
activating a beacon signal on a first terminal, wherein the beacon signal emits light across an angular search region;
scanning the angular search region using a beam steering element on the first terminal to sweep the beacon signal across candidate locations of a second terminal;
detecting a return signal at the first terminal indicating an angular direction of the second terminal;
computing a coarse alignment vector based on the detected return signal and directing the beam steering element toward an estimated location of the second terminal;
refining alignment by iteratively adjusting the beam steering element based on feedback from a spatially sensitive detector until a signal quality metric exceeds a predetermined acquisition threshold;
establishing a modulated data link between the first terminal and the second terminal by transmitting encoded optical data along a refined alignment vector;
monitoring the signal quality metric during the established modulated data link and computing a steering correction vector when the signal quality metric falls below a predetermined maintenance threshold; and
applying the steering correction vector to the beam steering element to maintain alignment in the presence of environmental disturbances.

12. The method of claim 11, wherein the first terminal and the second terminal are each mounted on or adjacent to a computing equipment rack within a data center facility, and wherein the beacon signal operates at a wavelength and power level selected to comply with applicable eye safety standards for deployment in an occupied facility.

13. The method of claim 11, wherein the return signal comprises at least one of a beacon signal from the second terminal or a retroreflected return from a retroreflector on the second terminal.

14. The method of claim 11, further comprising the steps of:
modulating the beacon signal on the first terminal to encode control data for communication to the second terminal;
receiving the beacon signal at the second terminal and extracting the control data from the beacon signal; and
coordinating operation between the first terminal and the second terminal based on the extracted control data without requiring a radio frequency link or a wired data connection between the first terminal and the second terminal.

15. The method of claim 11, further comprising the steps of:
detecting a link disruption event by identifying that the signal quality metric has fallen below a predetermined disruption threshold for a duration exceeding a timeout period;
classifying the link disruption event as either a temporary obstruction or a persistent failure;
entering a hold state upon classification as a temporary obstruction, wherein the beam steering element maintains a current alignment and monitors for signal return within a predefined hold window; and
initiating a recovery sequence upon classification as a persistent failure or upon expiration of the hold window, comprising a directed search across a narrowed angular region centered on a last known position of the second terminal.

16. The method of claim 15, wherein initiating the recovery sequence further comprises determining whether to re-acquire the second terminal or redirect the link to an alternative terminal or a relay based on a reconfiguration instruction from a network controller.

17. The method of claim 11, further comprising the steps of:
storing tracking history data comprising recent steering corrections and signal quality trends; and
computing a predictive adjustment to the beam steering element based on the stored tracking history data to compensate for periodic or anticipated disturbances prior to degradation of the signal quality metric below the predetermined maintenance threshold.

18. The method of claim 11, further comprising the steps of:
registering the first terminal and the second terminal in a network topology map maintained by a network controller, wherein each terminal reports a position, an orientation, an available steering range, and an operational status;
receiving a link assignment instruction from the network controller designating the second terminal as a partner for the first terminal;
reporting link status information to the network controller during the established modulated data link; and
receiving a reconfiguration instruction from the network controller directing the first terminal to terminate the established modulated data link and initiate the acquisition sequence with a third terminal designated as a reassigned partner.

19. The method of claim 11, further comprising the step of:
directing the modulated data link through a relay positioned at a location having line-of-sight to both the first terminal and the second terminal, wherein the relay redirects the modulated optical signal between the first terminal and the second terminal along a path that circumvents an obstruction between the first terminal and the second terminal.

20. The method of claim 11, further comprising the steps of:
generating image data of an environment including the second terminal using a camera on the first terminal; and
computing a pointing direction toward the second terminal based on image analysis of the image data to narrow the angular search region prior to scanning.
